(19) United States
(12) Patent Application Publication
(10) Pub. No.: US 2026/0285381 A1
(43) Pub. Date: Sep. 24, 2026

(54) WHEELED TOTE

(71) Applicant: Nickolas Brands, LLC, Sarasota, FL (US)

(72) Inventors: Nickolas Reinhart, Sarasota, FL (US); Joe Klein, Findlay, OH (US); Ben Sayalith, Findlay, OH (US)

(21) Appl. No.: 19/416,319

(22) Filed: Dec. 11, 2025

Related U.S. Application Data
(60) Provisional application No. 63/773,748, filed on Mar. 18, 2025.

(51) Int. Cl. B62B 1/12

(52) U.S. Cl. CPC B62B 1/12; B62B 3/02

(57) ABSTRACT

A wheeled tote can include a base wall, a first side wall, a second side wall, a first end wall, and a second end wall. Each of the side first side wall, the second side wall, the first end wall, and the second end wall can extend upwardly from the base wall to form a hollow interior cavity. A plurality of wheel wells can be formed in portions of the base wall. Each wheel well can have a corresponding wheel rotatably mounted within the wheel well. A first reinforcing portion can be disposed substantially centrally along a length of the base wall and a second reinforcing portion can be disposed substantially centrally along a width of the base wall and perpendicular to the first reinforcing portion. A reinforcing grid can be disposed on the first reinforcing portion and the second reinforcing portion.

### CROSS-REFERENCE TO RELATED APPLICATIONS

This application claims the benefit of U.S. Provisional Application No. 63/773,748, filed on Mar. 18, 2025. The entire disclosure of the above application is incorporated herein by reference.

### FIELD

The present technology relates to storage containers and organizational systems, and, more particularly, to portable storage containers with enhanced mobility features.

### INTRODUCTION

This section provides background information related to the present disclosure which is not necessarily prior art.

Storage containers serve an important role in organizing, storing, and transporting items. Basic storage containers with rectangular configurations and flat walls are often used for smaller applications. However, as storage loads increase in size and weight, certain structural limitations of basic storage containers may be more prevalent and more problematic. Likewise, large capacity storage containers face unique challenges with respect to maintaining structural integrity while accommodating substantial loads.

Wheeled storage containers with two-wheel configurations positioned at one end may present additional structural issues such as stability challenges during transport of heavy loads. For examples, single axle configurations may inadequately distribute weight across larger storage container bases. Further, basic wheel well designs may lack proper structural integration with storage container walls and bases, thereby negatively affecting durability during repeated use.

Storage containers without integrated support structures may also exhibit flexing or deformation under increased load size. Connection points between storage container walls and base sections may lack continuous reinforcement features, creating potential weak areas in the overall structure. Wall configurations without proper reinforcement may compromise the overall structural integrity of the storage container during heavy-duty use and transport of loads.

Certain container lid securing mechanisms, such as those relying on a basic snap fit, may not maintain consistent sealing with an increase in load size and weight. Further, protruding handles may create storage inefficiencies and potential hazards in storage environments. Additionally, handles disposed on only two opposing ends of a storage container may not provide a secure connection between the lid and the storage container that is sufficient to militate against flexing and deformation of the storage container with respect to the lid.

Accordingly, there is a continuing need for a storage container configured to store and transport an increased load size and that incorporates features that optimize structural reinforcement, enhance wheel support configurations, and improve the lid securing mechanism.

### SUMMARY

In concordance with the instant disclosure, a storage container configured to store and transport an increased load size and that incorporates features that optimize structural reinforcement, enhance wheel support configurations, and improve the lid securing mechanism, has surprisingly been discovered.

The present technology includes articles of manufacture, systems, and processes that relate to portable storage containers with enhanced mobility and stacking features.

In certain embodiments, a wheeled tote can include a base wall, a first side wall, a second side wall, a first end wall, and a second end wall. Each of the side first side wall, the second side wall, the first end wall, and the second end wall can extend upwardly from the base wall to form a hollow interior cavity. A plurality of wheel wells can be formed in portions of the base wall. Each wheel well can have a corresponding wheel rotatably mounted within the wheel well. A first reinforcing portion can be disposed substantially centrally along a length of the base wall and a second reinforcing portion can be disposed substantially centrally along a width of the base wall and perpendicular to the first reinforcing portion. A reinforcing grid can be disposed on the first reinforcing portion and the second reinforcing portion.

In certain embodiments, a wheeled tote can include a base wall, a first side wall, a second side wall, a first end wall, and a second end wall. Each of the side first side wall, the second side wall, the first end wall, and the second end wall can extend upwardly from the base wall to form a hollow interior cavity. A plurality of wheel wells can be formed in portions of the base wall, each wheel well having a corresponding wheel rotatably mounted within the wheel well, the plurality of wheel wells including a first wheel well formed adjacent the base wall, the first side wall, and the first end wall, and a second wheel well formed adjacent the base wall, the second side wall, and the first end wall. A first reinforcing portion can be disposed substantially centrally along a length of the base wall and a second reinforcing portion can be disposed substantially centrally along a width of the base wall and perpendicular to the first reinforcing portion. A reinforcing grid can be disposed on the first reinforcing portion and the second reinforcing portion.

In certain embodiments, a wheeled tote can include a base wall, a first side wall, a second side wall, a first end wall, and a second end wall. Each of the side first side wall, the second side wall, the first end wall, and the second end wall can extend upwardly from the base wall to form a hollow interior cavity. A plurality of wheel wells formed in portions of the base wall, each wheel well having a corresponding wheel rotatably mounted within the wheel well, the plurality of wheel wells including a first wheel well formed adjacent the base wall, the first side wall, and the first end wall, and a second wheel well formed adjacent the base wall, the second side wall, and the first end wall. A first reinforcing portion can be disposed substantially centrally along a length of the base wall and a second reinforcing portion can be disposed substantially centrally along a width of the base wall and perpendicular to the first reinforcing portion. A reinforcing grid can be disposed on the first reinforcing portion and the second reinforcing portion. A handle can be disposed adjacent the first end wall of the wheeled tote.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a wheeled tote including a lid according to an embodiment of the present disclosure;

FIG. 2 is a bottom perspective view thereof;

FIG. 3 is a top perspective view thereof without the lid;

FIG. 4 is a top plan view thereof without the lid;

FIG. 5 is a bottom elevational view thereof;

FIG. 6 is a front elevational view thereof;

FIG. 7 is a rear elevational view thereof;

FIG. 8 is a side elevational view thereof;

FIG. 9 is a top elevational view of a lid for a wheeled tote according to an embodiment of the present disclosure;

FIG. 10 is a top perspective view thereof; and

FIG. 11 is a bottom perspective view thereof.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures.

Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

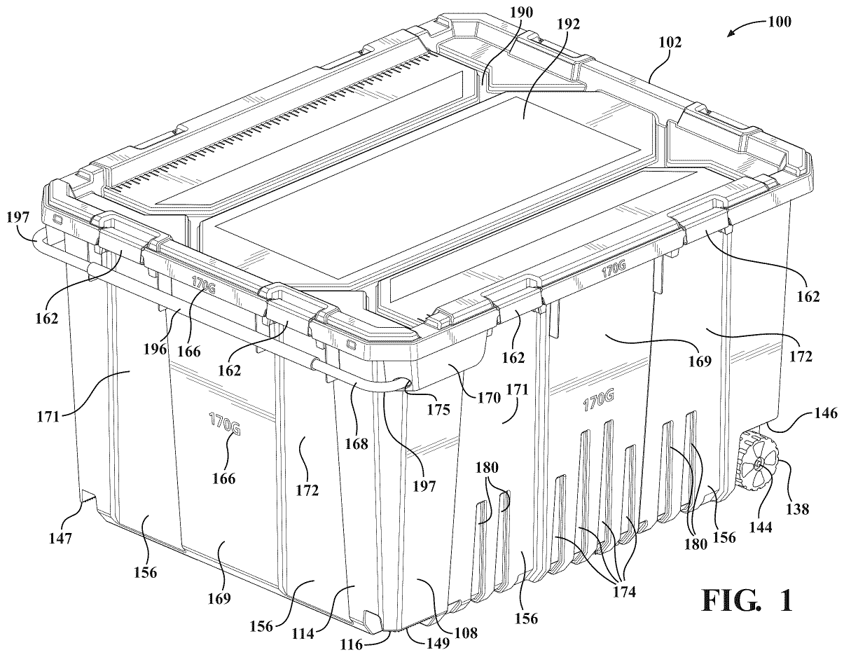

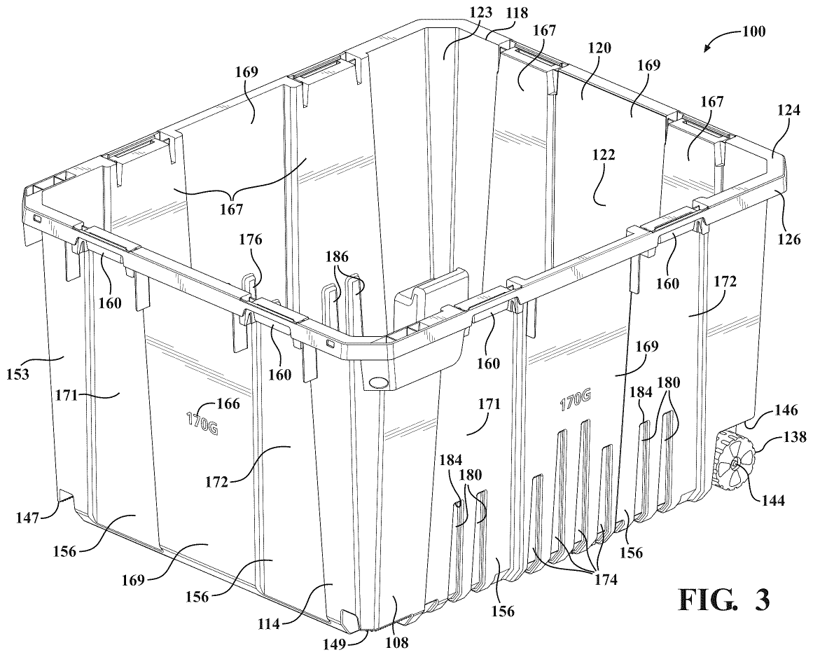

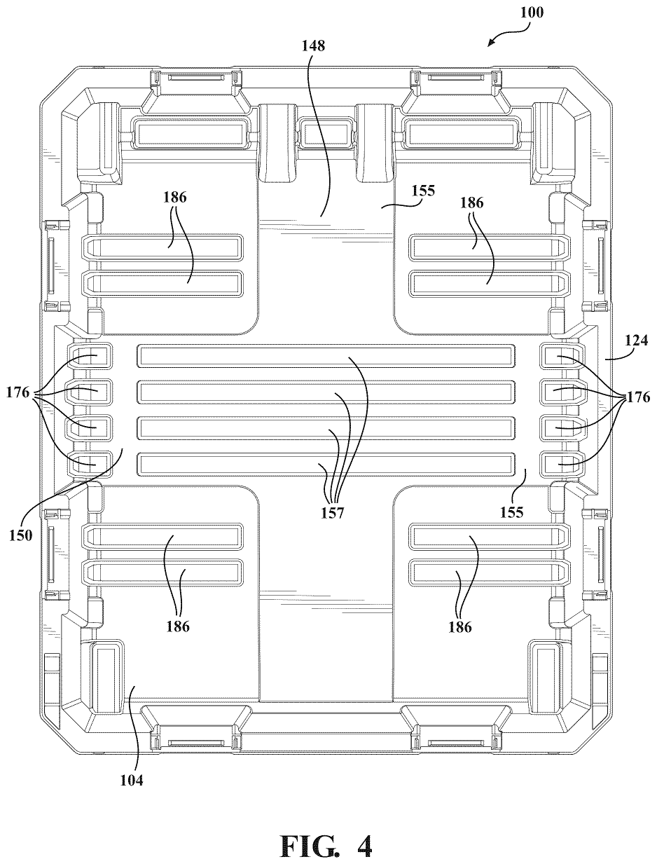

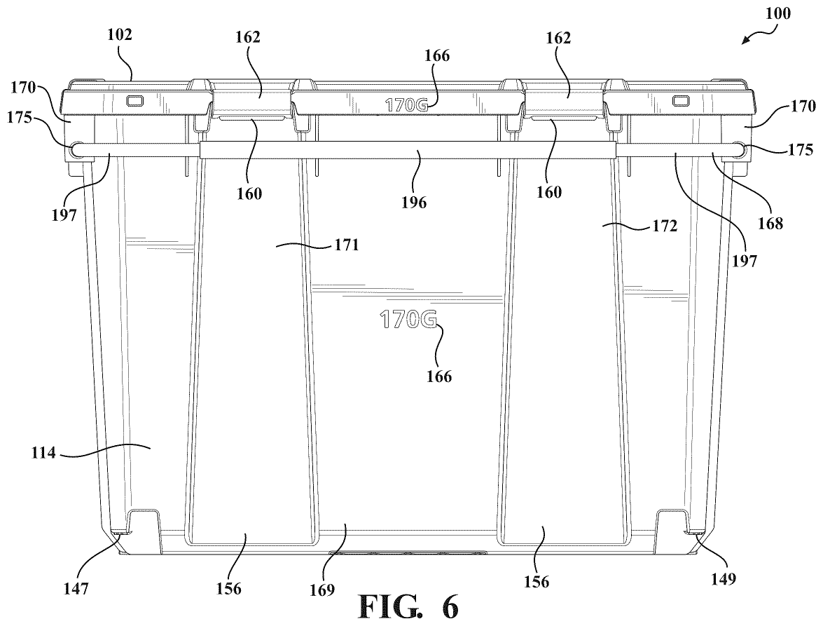

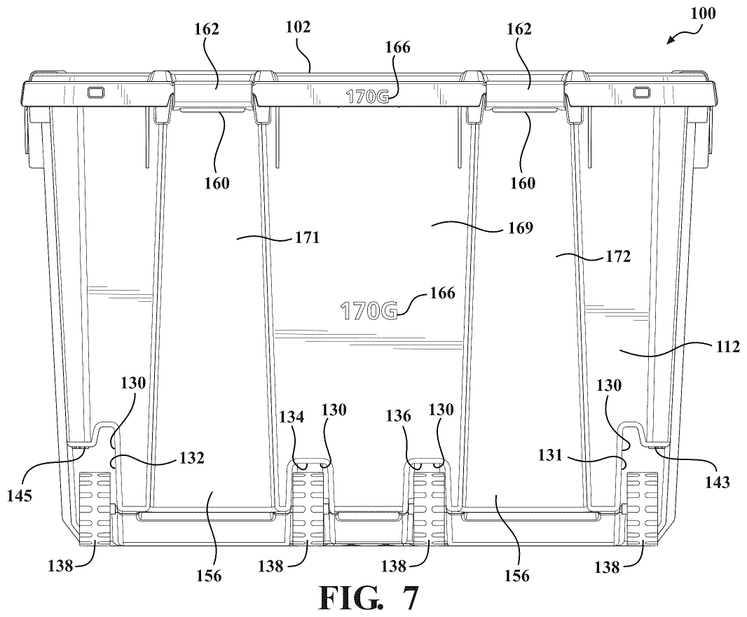

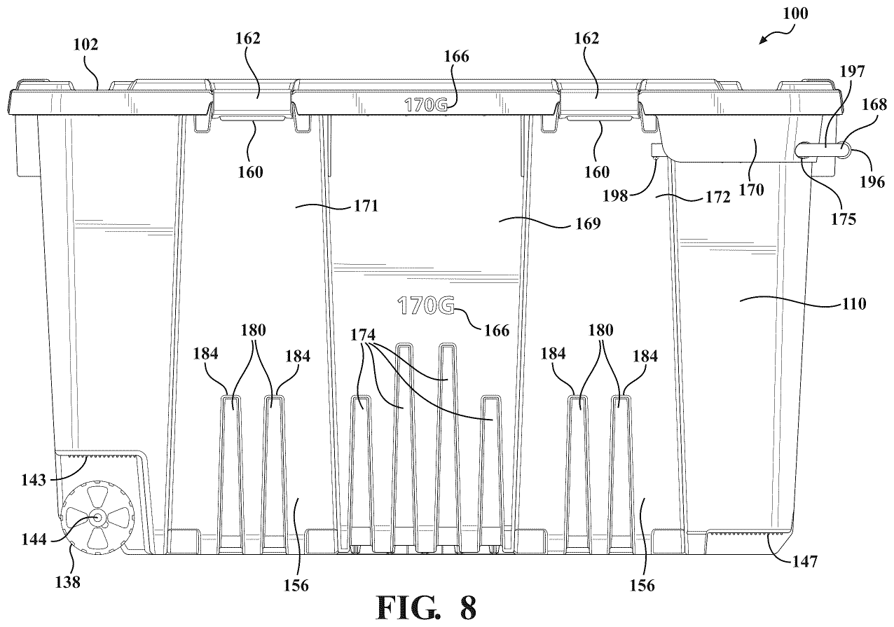

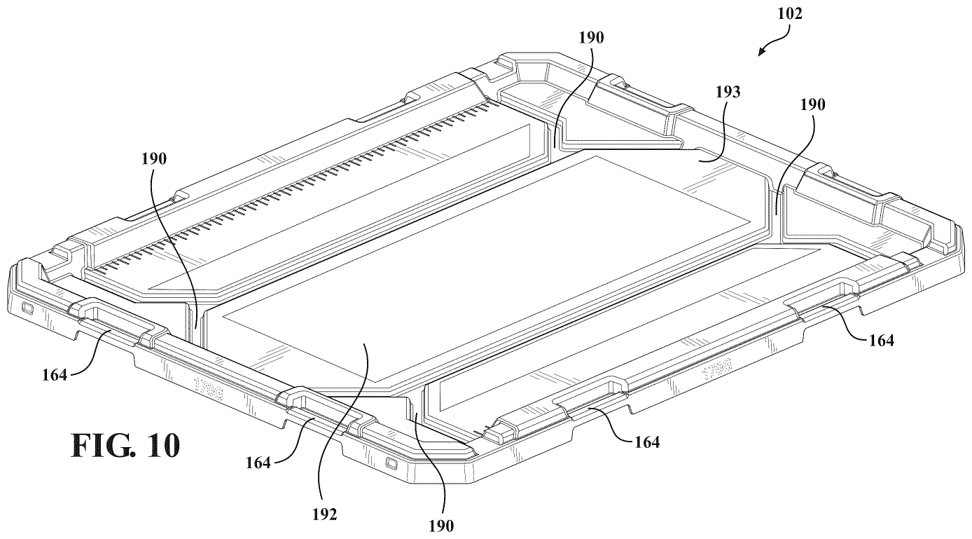

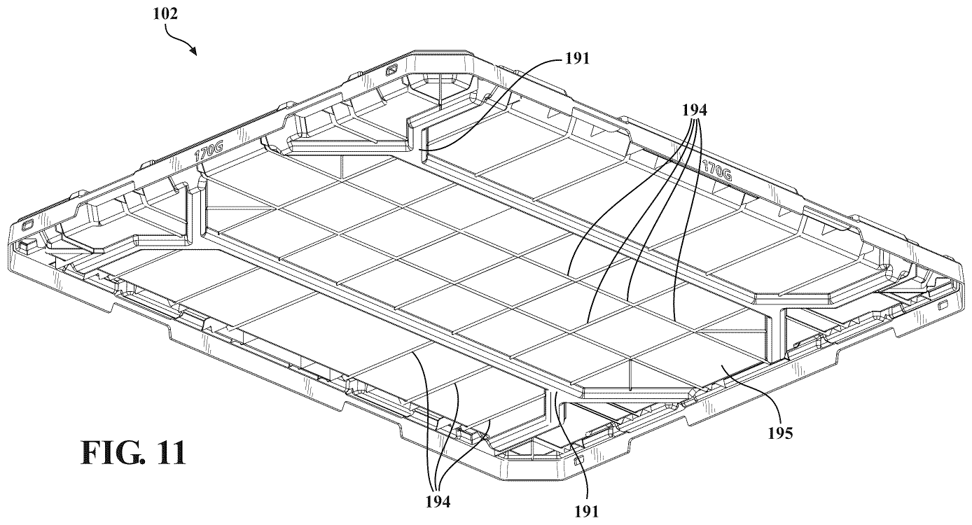

With reference to FIGS. 1-11, a wheeled tote 100 with a lid 102 is shown. As an example, the wheeled tote 100 can be a plastic storage tote. However, it should be appreciated that wheeled totes 100 made of different materials are contemplated and can therefore be included within the scope of this disclosure. The wheeled tote 100 can be manufactured from plastic through injection molding or blow molding processes. However, it should be appreciated that other processes and types of materials can be employed by a skilled artisan, for example, where the wheeled tote 100 can be formed and shaped from various metals such as aluminum.

The wheeled tote 100 can be configured as an extra-large capacity storage tote with reinforced construction features. As an example, the wheeled tote 100 can be configured as a 170-gallon capacity storage tote, which can be substantially larger than certain basic storage containers. The wheeled tote 100 can therefore be well-suited to accommodate and transport substantial loads, where structural elements can be incorporated to support such large-scale storage and transportation requirements as described in greater detail herein.

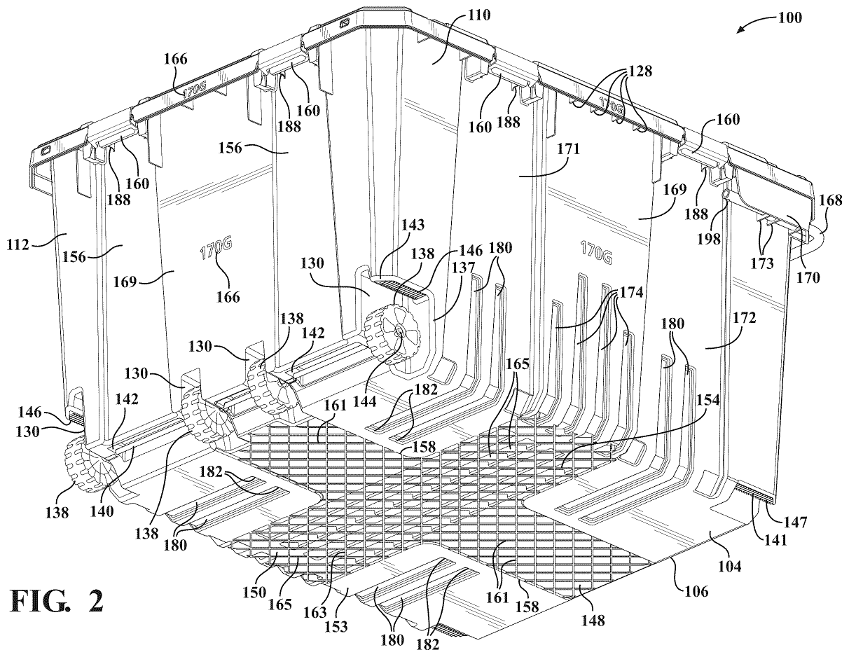

Now referring to FIG. 2, the wheeled tote 100 can include a base wall 104 having a peripheral edge 106. A first side wall 108 and a second side wall 110 disposed opposite the first side wall 108 can extend upwardly from the peripheral edge 106 of the base wall 104, and a first end wall 112 and a second end wall 114 disposed opposite the first end wall 112 can extend upwardly from the peripheral edge 106 of the base wall 104. Each of the first and second side walls 108, 110 and first and second end walls 112, 114 can be integrally formed with one another and can include a lower edge 116 that can be disposed on, coupled to, or integrally formed with the peripheral edge 106 of the base wall 104. The first and second side walls 108, 110, as well as the first and second end walls 112, 114, can be spaced apart from one another and can extend substantially perpendicular to the base wall 104.

The first and second side walls 108, 110 and the first and second end walls 112, 114 can each include an upper edge 118 that can be spaced apart from and disposed opposite the respective lower edge 116. The upper edge 118 of each of the first and second side walls 108, 110 and the first and second end walls 112, 114 can collectively define an opening 120 that can provide access to a hollow interior cavity 122 of the wheeled tote 100. The hollow interior cavity 122 can be defined by an interior surface 123 of the base wall 104, the first and second side walls 108, 110, and the first and second end walls 112, 114.

The upper edge 118 can include a lip 124 that can extend around the opening 120. The lip 124 can be configured to selectively receive and engage with the lid 102 to selectively cover the opening 120 and enclose the hollow interior cavity 122. The lip 124 can be circumscribed by a flange 126 that can extend from the lip 124. The flange 126 can extend at substantially ninety degrees relative to the lip 124 in a downward direction toward the base wall 104. A plurality of support ribs 128 can be disposed adjacent the opening 120. Each of the support ribs 128 can extend between and couple to the flange 126, the lip 124, and at least one of the adjacent first side wall 108, second side wall 110, first end was 112, and second end wall 114. The support ribs 128 can be configured to provide structural reinforcement to the lip 124, the flange 126, and the lid 102.

According to certain embodiments, one or more wheel wells 130 can be formed in portion(s) of the base wall 104. Embodiments include where a first wheel well 131 can be formed adjacent to the intersection of the base wall 104, the first side wall 108, and the first end wall 112, a second wheel well 132 can be formed adjacent to the intersection of the base wall 104, the second side wall 110, and the first end wall 112, a third wheel well 134 can be formed along the first end wall 112 adjacent the base wall 104, and a fourth wheel well 136 can be formed along the first end wall 112 adjacent the base wall 104 and adjacent the third wheel well 134. The third and fourth wheel wells 134, 136 can be positioned between the first wheel well 131 and the second wheel well 132. It should be appreciated that each wheel well 130 can have a portion thereof formed in one or more of the base wall 104, the first side wall 108, the second side wall 110, and the first end wall 112, as determined by a skilled artisan.

The wheel well 130 can be formed as a recessed portion extending inwardly from at least the bass wall 104 and the first end wall 112. In certain embodiments, the wheel well 130 can be formed as a recessed portion extending inwardly from the bass wall 104, the first end wall 112, and one of the first side wall 108 and the second side wall 110. The wheel well 130 can include an arched portion 137 configured to receive a wheel 138.

Each wheel 138 can be rotatably mounted within a wheel well 130. An axle 140 can be configured to rotatably mount the wheel 138 to the wheeled tote 100. It should be understood that more than one axle 140 can be provided where each axle 140 can rotatably mount and support one or more wheels 138. The axle 140 can be rotatably supported to facilitate smooth movement of the wheeled tote 100. In certain embodiments, an axel support wall 142 can be included in the wheel well 130. The axel 140 can be configured to extend through the axel support wall 142. A fastener 144 such as a push nut or clip, for example, can be disposed on the ends of the axle 140 to facilitate keeping the wheel 138 on the axle 140 and the axle 140 mounted to the wheeled tote 100. It should be appreciated that the wheeled tote 100 can include additional axle apertures and/or axle tunnels configured to receive the axle 140 and facilitate support and a smooth rotation of the wheel 138 and/or axle 140, as determined by a skilled artisan. A lubricant can be provided on a portion of the wheel 138, the axle 140, the axel support wall 142, and any additional axle apertures and/or axle tunnels to facilitate a smooth rotation of the wheel 138 and/or axle 140.

Although the drawings depict the first, second, third, and fourth wheel wells 131, 132, 134, 1346 and four corresponding wheels 138, it should be appreciated that one of skill in the art can select and incorporate any suitable number and arrangement of wheel wells 130 and wheels 138, as desired, based on the size and intended use of the wheeled tote 100. The number, size, configuration, and placement of the wheel wells 130 and wheels 138 can be scaled accordingly to provide adequate support and mobility for wheeled totes 100 of varying dimensions.

The wheeled tote 100 can include a grab portion 146 formed in one or more of the base wall 104, the first side wall 108, the second side wall 110, the first end wall 112, and the second end wall 114. In certain more particular embodiments, a first grab portion 143 can be positioned proximate to the first wheel well 131, and a second grab portion 145 can be positioned proximate to the second wheel well 132. Each of the first and second grab portions 143, 145 can include an additional recess extending upwardly from the first and second wheel wells 131, 132, respectively, into the hollow interior cavity 122 of the wheeled tote 100.

A third grab portion 147 and a fourth grab portion 149 of the wheeled tote 100 can be positioned adjacent the second end wall 114 of the wheeled tote 100 opposite the first grab portion 143 and the second grab portion 145. The third grab portion 147 and the fourth grab portion 149 can be formed as a recess extending upwardly from the base wall 104 into the hollow interior cavity 122 of the wheeled tote 100. Each grab portion 146 can be configured to facilitate lifting and maneuvering of the wheeled tote 100, and each grab portion 146 can include a contoured and/or textured surface 141 that can be shaped to accommodate a hand of a user and to militate against the hand of the user slipping during lifting and maneuvering of the wheeled tote 100. Each grab portion 146 can extend upwardly from the base wall 104 and/or the wheel well 130 to provide an elevated gripping mechanism that can enable ergonomic access for lifting and repositioning of the wheeled tote 100.

With reference to FIGS. 2, 4, and 5, the base wall 104 can include a first reinforcing portion 148 that can be disposed substantially centrally along a length of the wheeled tote 100, and a second reinforcing portion 150 that can be disposed substantially centrally along a width of the wheeled tote 100. The first and second reinforcing portions 148, 150 can be disposed perpendicular to one another to form a cross-shaped configuration, according to certain embodiments. It should be appreciated that the third and the fourth wheel wells 134, 136 can be disposed within bounds of and/or adjacent the first reinforcing portion 148. Such positioning of the third and fourth wheel wells 134, 136 within bounds of and/or adjacent the first reinforcing portion 148 can provide enhanced structural support for load distribution during transport of the wheeled tote 100. The first reinforcing portion 148 can facilitate transmission of forces from the wheels 138 positioned in the third and the fourth wheel wells 134, 136 through the reinforced base wall 104, where stress can occur during movement of the wheeled tote 100.

The first and second reinforcing portions 148, 150 can be recesses formed in an exterior surface 153 of the wheeled tote 100 at the base wall 104. The first and second reinforcing portions 148, 150 can form corresponding base wall projections 155 in the interior surface 123 of the base wall 104 that can extend upwardly into the hollow interior cavity 122. The second reinforcing portion 150 can include channels 152 that can be formed along the width of the wheeled tote 100. The channels 152 can form corresponding raised portions 157 that can extend upwardly from the second reinforcing portion 150 into the hollow interior cavity 122.

A reinforcing grid 154 can be disposed on, coupled to, or integrally formed with the first and second reinforcing portions 148, 150 and the channels 152. The reinforcing grid 154 can be aligned and flush with the exterior surface 153 of the base wall 104 adjacent the first and second reinforcing portions 148, 150 and can be oriented at a substantially forty-five degree angle 159 relative to a perimeter 158 of the first and second reinforcing portions 148, 150 formed by the exterior surface 153 of the base wall 104. In certain embodiments, the reinforcing grid 154 can abut the exterior surface 153 of the base wall 104 adjacent the first reinforcing portion 148 and the second reinforcing portion 150 at a substantially forty-five degree angle. The overlapping configuration of the reinforcing grid 154 and the recessed first and second reinforcing portions 148, 150, in addition to the channels 152, can create a multi-layered support structure configured to enhance the structural integrity of the base wall 104 and militate against a bending or bowing of the base wall 104 and the wheeled tote 100.

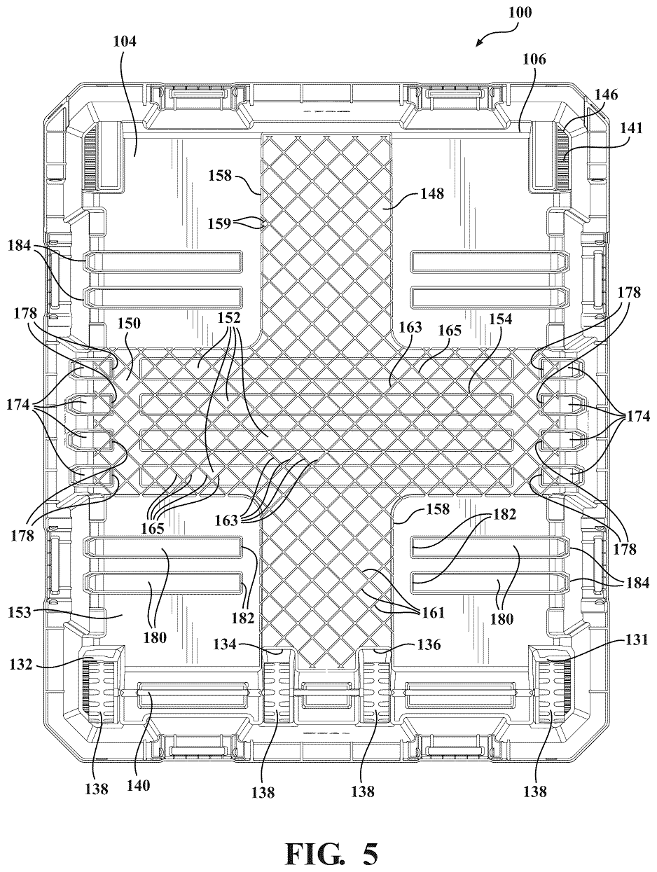

The reinforcing grid 154 can include a plurality of intersecting grid walls 161 configured to form a grid pattern, as shown in FIG. 5. The plurality of intersecting grid walls 161 can form a plurality of ninety-degree angles, as an example. The reinforcing grid 154 can include a plurality of first grid wall sections 163 disposed adjacent the channels 152 and a plurality of second grid wall sections 165 disposed in the channels 152 of the second reinforcing section 150. The second grid wall sections 165 can be configured to extend into the channels 152 and provide enhanced support to the base wall 104 of the wheeled tote 100.

Each of the first and second side walls 108, 110 and the first and second end walls 112, 114 can include a recessed reinforcing wall 156 integrally formed therein. The reinforcing wall 156 can extend from the exterior surface 153 of the wheeled tote 100 at one of the first and second side walls 108, 110 or the first and second end walls 112, 114, into the hollow interior cavity 122, thereby forming a corresponding side wall projection 167 in the hollow interior cavity 122 of the wheeled tote 100. In certain embodiments, each of the first and second side walls 108, 110 and the first and second end walls 112, 114 can include a central portion 169 abutting, overlapping, and/or adjacent one of the first and second reinforcing portions 148, 150. The central portion 169 can be positioned between a first reinforcing wall 171 and a second reinforcing wall 172, as shown in FIGS. 1, 3, and 6-8, according to certain embodiments.

In certain embodiments, the central portion 169 of each of the first and second side walls 108, 110 can include at least one recessed central wall channel 174 configured to extend inwardly from the exterior surface 153 into the hollow interior cavity 122, thereby forming a corresponding central wall projection 176 in the hollow interior cavity 122. In certain embodiments, each of the central portion 169 of the first side wall 108 and the central portion 169 of the second side wall 110 can include a plurality of central wall channels 174. Each central wall channel 174 can have a first end 178 configured to abut, overlap, or extend into the second reinforcing portion 150 and/or the reinforcing grid 154. Each central wall channel 174 disposed in the central portion 169 of the first side wall 108 and the second side wall 110 can line up with a corresponding channel 152 formed in the base wall 104, as shown in FIGS. 2 and 5.

The wheeled tote 100 can include a reinforcing wall channel 180 formed in the reinforcing wall 156 disposed in the first and second side walls 108, 110, according to certain embodiments. The reinforcing wall channels 180 can have a first end 182 disposed in the base wall 104 and a second end 184 disposed in one of the first side wall 108 and the second side wall 110. The reinforcing wall channel 180 can be configured to extend inwardly from the exterior surface 153 of the wheeled tote 100 into the hollow interior cavity 122, thereby forming a corresponding reinforcing wall channel projection 186 in the hollow interior cavity 122. The reinforcing wall channel 180 formed in the reinforcing wall 156 can be configured to extend into and along the base wall 104 to provide continuous structural reinforcement between the first side wall 108 or the second side wall 110 and base wall 104.

The wheeled tote 100 can include hand grips 160 that can be positioned between the lip 124, the flange 126, and one of the first side wall 108, the second side wall 110, the first end wall 112, and the second end wall 114. In certain embodiments, more than one hand grip 160 can be disposed on each of the first and second side walls 108, 110 and on each of the first and second end walls 112, 114. The hand grips 160 can be positioned adjacent each reinforcing wall 156 and can be configured to flank each central portion 169 of the wheeled tote 100. The hand grips 160 can extend downwardly from the lip and can be configured to provide structural reinforcement between each of the first side wall 108, the second side wall 110, the first end wall 112, and the second end wall 114 and the flange 126. Grip support ribs 188 can be disposed between the hand grip 160, the lip 124, and the corresponding first side wall 108, second side wall 110, first end wall 112, or second end wall 114 and can be configured to provide structural reinforcement. The wheeled tote 100 can include clamps 162 that can be disposed adjacent each hand grip 160. The clamps 162 can be configured to selectively secure the lid 102 to the wheeled tote 100.

The lid 102 can be configured to selectively cover the opening 120 of the wheeled tote 100. The lid 102 can have dimensions that can substantially correspond to dimensions of the wheeled tote 100. The lid 102 can be configured to selectively engage with the lip 124 and the flange 126 of the wheeled tote 100, where such engagement can include recessed sections 164 that can be configured to selectively receive clamps 162. The lid 102 can be pivotally coupled to the wheeled tote 100, as an example. In alternative embodiments, the lid 102 can be coupled to the wheeled tote 100 via a coupling means such as a snap connection or a hinged connection. The lid 102 can be configured to selectively enclose the hollow interior cavity 122 of the wheeled tote 100.

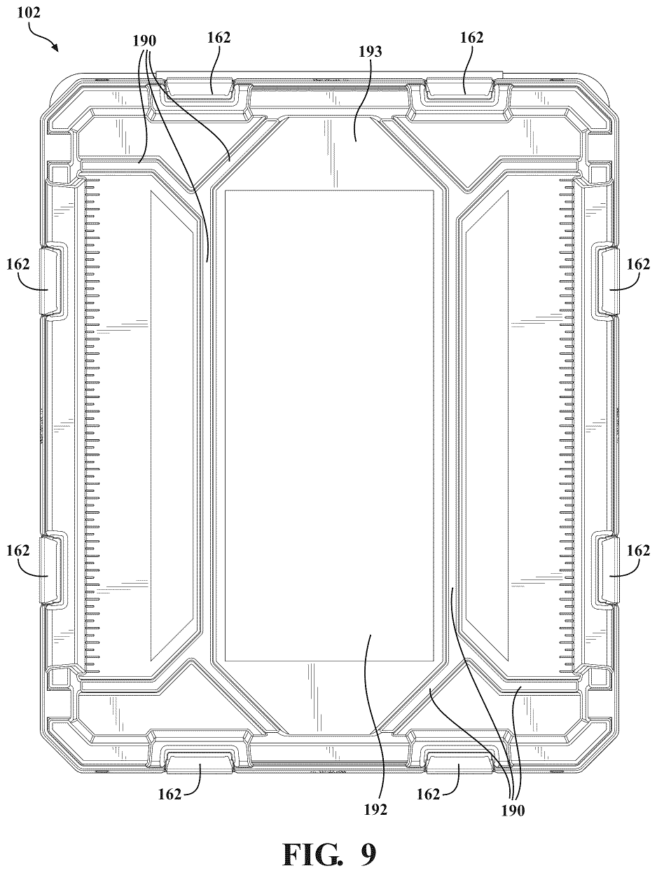

As shown in FIGS. 9-11, a lid channel 190 can be formed in the surface of the lid 102 to increase a strength of the lid 102 and mitigate against a bending or bowing of the lid 102. In certain embodiments, the lid channel 190 can define a substantially planar panel area 192 on an exterior surface 193 of the lid 102 for the presentation of logos, decorative surface treatments, and the like. The lid channel 190 can form a corresponding lid projection 191 configured to extend into the hollow interior cavity 122 of the wheeled tote 100 and enhance the structural integrity of the lid 102 during storage and stacking. Similarly, one or more reinforcing ribs 194 can be formed on an interior surface 195 of the lid 102 to increase a strength of the lid 102 and mitigate against a bending or bowing of the lid 102.

The wheeled tote 100 and lid 102 can include corresponding indicia 166 that can be disposed on each of the wheeled tote 100 and the lid 102 to indicate a match and/or proper orientation of the wheeled tote 100 and the lid 102 with respect to one another. The indicia 166 can be configured to facilitate matching of the lid 102 to a corresponding wheeled tote 100. The lid 102 can include additional indicia 166 that can be disposed on the lid 102 and/or the wheeled tote 100 to indicate functional portions thereof. Such functional indicia 166 can be configured to demarcate locations for securing the lid 102 to the wheeled tote 100, such as the recessed sections 164 that can be configured to receive the clamps 162. The lid 102 can further include indicia 166 configured to indicate locations and/or functional elements such as apertures (not shown) configured for securing bungee cords, locks, and zip ties, for example, to the wheeled tote 100.

The indicia 166 can be configured in various forms, where such forms can include numbers, words, symbols, or other suitable markings that can be selected by a skilled artisan. The indicia 166 can provide multiple advantages, including facilitating identification of corresponding lids 102 and wheeled totes 100 during manufacturing and shipping processes. The indicia 166 can further enable retail establishments to readily match lids 102 with corresponding wheeled totes 100, where such matching can enhance efficiency in inventory management and product display. Additionally, the indicia 166 can allow users to easily identify and pair corresponding lids 102 and wheeled totes 100 during use.

The wheeled tote 100 can include a handle 168, as shown in FIGS. 1, 2, and 6, that can be disposed adjacent to the first end wall 112. The handle 168 can be selectively movable between a stored position and an extended position. The first end wall 112 can include handle mounts 170 that can be disposed at corners thereof. The handle mounts 170 can include apertures 175 or any other suitable mechanism that can be configured to slidably receive or otherwise secure the handle 168 with respect to the wheeled tote 100. The handle mounts 170 can be configured to provide structural support for the handle 168 during movement of the wheeled tote 100. The handle mounts 170 can include at least one handle rib 173 for reinforcing the handle mount 170. Additionally, the at least one handle rib 173 can facilitate providing strength to support the weight of the wheeled tote 100 when lifted, tilted, and/or towed by the handle 168, especially where the handle 168 is in the extended position.

In certain embodiments, the handle 168 can have a substantially rectangular U-shape with rounded corners. The handle 168 can be formed from metal tubing bent into a U-shape, injection molded plastic/polymer, or any other suitable material that can provide a desired strength to enable the wheeled tote 100 to be lifted, tilted on the wheels 138, and pulled. The handle 168 can have a gripping portion 196 and an arm portion 197. The gripping portion 196 can be selectively disposed adjacent the flange 126 in the stored position and can be slidably distanced from the flange 126 in the extended position.

In certain embodiments, a detent or other catching mechanism (not shown) can be disposed in the handle mount 170 or on the wheeled tote 100 and configured to cooperate with the handle 168 to maintain the handle 168 in one of the stored position and the extended position. The handle 168 can include a handle projection 198 disposed adjacent each distal end of the arm portion 197. The handle projection 198 can be a screw, a rivet, or the like configured to contact the handle mounts 170 and/or handle rib 173 and militate against a further extension of the handle 168 or a removal of the handle 168 from the handle mount 170. The handle projection 198 can militate against the handle 168 being completely removed from the wheeled tote 100. The handle 168 can include a handle grip 196. The handle grip 196 can be configured to provide a comfortable gripping surface for the user during operation and can be formed from foam, rubber, plastic, or any other suitable material.

The wheeled tote 100 can advantageously include a plurality of reinforcing elements such as the first and second reinforcing portions 148, 150, the reinforcing grid 154, and the channels 152 that are configured to cooperate with one another and provide enhanced structural support throughout the wheeled tote 100. More specifically, the cross-shaped configuration formed by the first and second reinforcing portions 148, 150 can provide centralized support across the base wall 104, and the overlapping reinforcing grid 154 can create additional structural reinforcement. The channels 152 formed within the second reinforcing portion 150, as well as the second grid wall sections 165 disposed in the channels 152 of the second reinforcing section 150, can provide supplemental support along the width of the base wall 104. The base wall projections 155 and the raised portions 157 extending into the hollow interior cavity 122 of the wheeled tote 100 can provide additional structural support for storage and transport of heavy-duty loads.

Additional reinforcing elements such as the reinforcing walls 156, the central portions 169 in alignment with the first and second reinforcing portions 148, 150 and flanked by the reinforcing walls 156, the central wall channels 174, and the reinforcing wall channels 180 can form continuous, enhanced structural reinforcement configured to optimize the structural integrity and durability of the base wall 104, the first and second side walls 108, 110, and the first and second end walls 112, 114. More specifically, the central wall channels 174 and the reinforcing wall channels 180 extending from each of the first and second side walls 108, 110 to and/or into the base wall 104 can form an integrated support network where each of the first and second side walls 108, 110 and the base wall 104 intersect. The side wall projections 167, central wall projections 176, and the reinforcing wall channel projections 186 extending into the hollow interior cavity 122 can provide multi-directional structural support both vertically and laterally.

The position and structure of the first wheel well 131, the second wheel well 132, the third wheel well 134, and the fourth wheel well 136 can further optimize stability and performance during transport of heavy-duty loads and provide enhanced protection for the wheels 138. The grab portions 146 enable ergonomic access for lifting and repositioning the wheeled tote 100 from the base wall 104 and the durable handle 168 enables ergonomic, easy lifting and transport in combination with the wheels 138. The lid channels 190 formed in the exterior surface 193 of the lid 102 and the reinforcing ribs 194 and lid projections 191 formed on the interior surface 195 of the lid 102 enhance the structural integrity of the lid 102 and militate against bending or bowing of the lid 102.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

1. A wheeled tote comprising:
a base wall, a first side wall, a second side wall, a first end wall, and a second end wall, each of the side first side wall, the second side wall, the first end wall, and the second end wall extending upwardly from the base wall to form a hollow interior cavity;
a plurality of wheel wells, each wheel well having a portion thereof formed in the base wall, each wheel well having a corresponding wheel rotatably mounted within the wheel well;
a first reinforcing portion formed as a recess in an exterior surface of the base wall and disposed substantially centrally along a length of the base wall;
a second reinforcing portion formed as a recess in an exterior surface of the base wall and disposed substantially centrally along a width of the base wall and perpendicular to the first reinforcing portion, and each of the first reinforcing portion and the second reinforcing portion form a corresponding base wall projection in an interior surface of the base wall, the base wall projection extending upwardly into the hollow interior cavity; and
a reinforcing grid disposed within the recesses of the first reinforcing portion and the second reinforcing portion, the reinforcing grid having a height substantially equal to a depth of the first reinforcing portion and the second reinforcing portion such that the reinforcing grid is flush with the exterior surface of the base wall adjacent the first reinforcing portion and the second reinforcing portion.

2. (canceled)

3. The wheeled tote of claim 1, wherein the second reinforcing portion includes a channel formed along the width of the base wall.

4. (canceled)

5. The wheeled tote of claim 1, wherein the reinforcing grid abuts a perimeter of the first reinforcing portion and the second reinforcing portion at a substantially forty-five degree angle, and wherein the perimeter is formed by the exterior surface of the base wall adjacent the first reinforcing portion and the second reinforcing portion.

6. The wheeled tote of claim 1, wherein the reinforcing grid includes a plurality of intersecting grid walls configured to form a plurality of ninety-degree angles.

7. The wheeled tote of claim 3, wherein the reinforcing grid includes a plurality of intersecting grid walls and wherein the plurality of intersecting grid walls includes a plurality of first grid wall sections disposed adjacent the channel and a plurality of second grid wall sections disposed in the channel.

8. The wheeled tote of claim 1, wherein each of the first side wall, the second side wall, the first end wall, and the second end wall includes a recessed reinforcing wall formed in an exterior surface of the wheeled tote.

9. The wheeled tote of claim 8, wherein the recessed reinforcing wall forms a corresponding side wall projection in an interior surface of the wheeled tote, the side wall projection extending into the hollow interior cavity.

10. The wheeled tote of claim 8, wherein a central portion is disposed between a first recessed reinforcing wall and a second recessed reinforcing wall, the central portion disposed adjacent at least one of the first reinforcing portion and the second reinforcing portion.

11. The wheeled tote of claim 10, wherein the central portion includes at least one recessed central wall channel formed in the exterior surface of the wheeled tote.

12. The wheeled tote of claim 11, wherein the recessed central wall channel includes a first end configured to extend into the second reinforcing portion.

13. The wheeled tote of claim 11, wherein the recessed central wall channel includes a first end configured to extend into the reinforcing grid.

14. The wheeled tote of claim 8, wherein the recessed reinforcing wall includes a reinforcing wall channel formed in the exterior surface and configured to extend into the hollow interior cavity.

15. The wheeled tote of claim 14, wherein the reinforcing wall channel includes a first end disposed in the base wall and a second end disposed in one of the first side wall and the second side wall.

16. A wheeled tote comprising:
a base wall, a first side wall, a second side wall, a first end wall, and a second end wall, each of the side first side wall, the second side wall, the first end wall, and the second end wall extending upwardly from the base wall to form a hollow interior cavity;
a plurality of wheel wells, each wheel well having a portion thereof formed in the base wall, each wheel well having a corresponding wheel rotatably mounted within the wheel well, the plurality of wheel wells including a first wheel well formed adjacent the base wall, the first side wall, and the first end wall, and a second wheel well formed adjacent the base wall, the second side wall, and the first end wall;
a first reinforcing portion formed as a recess in an exterior surface of the base wall and disposed substantially centrally along a length of the base wall;
a second reinforcing portion formed as a recess in an exterior surface of the base wall and disposed substantially centrally along a width of the base wall and perpendicular to the first reinforcing portion, and each of the first reinforcing portion and the second reinforcing portion form a corresponding base wall projection in an interior surface of the base wall, the base wall projection extending upwardly into the hollow interior cavity; and
a reinforcing grid disposed within the recesses of the first reinforcing portion and the second reinforcing portion, the reinforcing grid having a height substantially equal to a depth of the first reinforcing portion and the second reinforcing portion such that the reinforcing grid is flush with the exterior surface of the base wall adjacent the first reinforcing portion and the second reinforcing portion.

17. The wheeled tote of claim 16, wherein the plurality of wheel wells includes a third wheel formed adjacent the first end wall and the base wall and a fourth wheel well formed adjacent the first end wall and the base wall, each of the third wheel well and the fourth wheel well positioned between the first wheel well and the second wheel well.

18. The wheeled tote of claim 16, wherein a first grab portion is formed in the base wall, the first side wall, and the first end wall and a second grab portion is formed in the base wall, the second side wall, and the first end wall.

19. A wheeled tote comprising:
a base wall, a first side wall, a second side wall, a first end wall, and a second end wall, each of the side first side wall, the second side wall, the first end wall, and the second end wall extending upwardly from the base wall to form a hollow interior cavity;
a plurality of wheel wells, each wheel well having a portion thereof formed in the base wall, each wheel well having a corresponding wheel rotatably mounted within the wheel well, the plurality of wheel wells including a first wheel well formed adjacent the base wall, the first side wall, and the first end wall, and a second wheel well formed adjacent the base wall, the second side wall, and the first end wall;
a first reinforcing portion formed as a recess in an exterior surface of the base wall and disposed substantially centrally along a length of the base wall;
a second reinforcing portion formed as a recess in an exterior surface of the base wall and disposed substantially centrally along a width of the base wall and perpendicular to the first reinforcing portion, and each of the first reinforcing portion and the second reinforcing portion form a corresponding base wall projection in an interior surface of the base wall, the base wall projection extending upwardly into the hollow interior cavity;
a reinforcing grid disposed within the recesses of the first reinforcing portion and the second reinforcing portion, the reinforcing grid having a height substantially equal to a depth of the first reinforcing portion and the second reinforcing portion such that the reinforcing grid is flush with the exterior surface of the base wall adjacent the first reinforcing portion and the second reinforcing portion; and
a handle disposed adjacent the first end wall.

20. The wheeled tote of claim 19, wherein the handle is selectively movable between a stored position and an extended position.
